(19) United States
(12) Patent Application Publication
(10) Pub. No.: US 2023/0219442 A1
(43) Pub. Date: Jul. 13, 2023

(54) VEHICLE AND METHOD FOR EXTERNAL CHARGING

(71) Applicant: TOYOTA JIDOSHA KABUSHIKI KAISHA, Toyota-shi Aichi-ken (JP)

(72) Inventors: Ryosuke OYA, Toyota-shi Aichi-ken (JP); Yu SHIMIZU, Nagakute-shi Aichi-ken (JP)

(73) Assignee: TOYOTA JIDOSHA KABUSHIKI KAISHA, Toyota-shi Aichi-ken (JP)

(21) Appl. No.: 17/984,342

(22) Filed: Nov. 10, 2022

(30) Foreign Application Priority Data
Jan. 13, 2022 (JP) 2022-003735

(51) Int. Cl. B60L 53/62; B60L 58/24

(52) U.S. Cl. CPC B60L 53/62; B60L 58/24

(57) ABSTRACT

A vehicle in which a battery is charged with supplied power from a power supply outside the vehicle includes the battery, a temperature sensor which detects a temperature of the battery, a temperature raising device which raises the temperature of the battery, and a control device. The control device is configured to, in a period in which the temperature of the battery is lower than a reference temperature during execution of the external charging, execute power storage amount control for raising the temperature of the battery by driving the temperature raising device while keeping a power storage amount of the battery within a predetermined range. The control device is configured to, when the supplied power is smaller than a possible minimum value of consumed power of the temperature raising device in the power storage amount control, intermittently operate the temperature raising device with the battery receiving the supplied power continuously.

### CROSS-REFERENCE TO RELATED APPLICATION

This application claims priority to Japanese Patent Application No. 2022-003735 filed on Jan. 13, 2022, incorporated herein by reference in its entirety.

### BACKGROUND

### 1. Technical Field

The present disclosure relates to a vehicle capable of external charging in which electric power is supplied from the outside of the vehicle to charge an on-board battery, and a method for external charging.

### 2. Description of Related Art

A battery system disclosed in Japanese Unexamined Patent Application Publication No. 2017-99057 (JP 2017-99057 A) prohibits driving of a temperature raising mechanism with a state of charge (SOC) of a main battery lower than a charging reference value when electric power supplied from an external power supply to a vehicle is smaller than reference electric power. The battery system first performs charging until the SOC of the main battery reaches a value equal to or higher than the charging reference value, and then executes a temperature raising process (see JP 2017-99057 A).

### SUMMARY

In external charging, when the temperature of a battery is lower than a reference temperature, a temperature raising device may be operated to raise the temperature of the battery to the reference temperature or higher. In this case, the electric power supplied from an external power supply is divided into charging power for charging the battery and electric power for driving the temperature raising device (electric power consumed by the temperature raising device).

When the supplied power is sufficiently large, the charging of the battery and the driving of the temperature raising device can be executed simultaneously. In some cases, however, the supplied power may be small to the extent that the charging of the battery and the driving of the temperature raising device cannot be executed simultaneously. In such a case, the temperature raising device needs to be stopped in order to charge the battery. The battery system disclosed in JP 2017-99057 A adopts a configuration in which the temperature raising process is executed after the charging when the electric power is smaller than the reference electric power. Focusing on a period required for the external charging (a period required to charge the battery and a period required to raise the temperature), there is room for further improvement.

The present disclosure can solve the above challenge and can suppress an increase in the period required for the external charging when the temperature of the battery is lower than the reference temperature during the external charging.

(1) A vehicle according to a first aspect of the present disclosure is a vehicle configured to perform external charging in which a battery in the vehicle is charged with supplied power that is supplied from a power supply outside the vehicle. The vehicle includes the battery, a temperature sensor configured to detect a temperature of the battery, a temperature raising device configured to raise the temperature of the battery, and a control device configured to control the external charging and the temperature raising device. The control device is configured to, in a period in which the temperature of the battery is lower than a reference temperature during execution of the external charging, execute power storage amount control for raising the temperature of the battery by driving the temperature raising device while keeping a power storage amount of the battery within a predetermined range. The control device is configured to, when the supplied power is smaller than a possible minimum value of consumed power of the temperature raising device in the power storage amount control, keep the power storage amount of the battery within the predetermined range while intermittently operating the temperature raising device with the battery receiving supplied power continuously.

According to the configuration described above, the vehicle continuously receives the supplied power. The received supplied power is used, for example, to drive the temperature raising device, and a shortage is compensated with electric power taken out from the battery. Therefore, the electric power taken out from the battery to drive the temperature raising device can be reduced as compared with a case where the supplied power is not received. Thus, it is possible to slow down a decrease in the power storage amount of the battery. Alternatively, for example, the battery is charged with the received supplied power, and the electric power for driving the temperature raising device is taken out from the battery. Therefore, it is possible to slow down the decrease in the power storage amount of the battery as compared with the case where the supplied power is not received. Since the decrease in the power storage amount of the battery can be slowed down, the driving period of the temperature raising device can be lengthened. As a result, the temperature of the battery can quickly be raised to the reference temperature. Accordingly, it is possible to suppress the increase in the period required for the external charging.

(2) In the vehicle according to the aspect described above, the control device may be configured to, when the power storage amount of the battery decreases to a lower limit value of the predetermined range in the power storage amount control, stop the temperature raising device and charge the battery with the supplied power.

According to the configuration described above, the power storage amount of the battery can appropriately be kept within the predetermined range.

(3) In the vehicle according to the aspect described above, the control device may be configured to, when the supplied power is larger than a possible maximum value of the consumed power in the power storage amount control, intermittently charge the battery to keep the power storage amount of the battery within the predetermined range while operating the temperature raising device at all times.

According to the configuration described above, the temperature of the battery can quickly be raised to the reference temperature because the temperature raising device is operated at all times.

(4) In the vehicle according to the aspect described above, the control device may be configured to, when the supplied power is smaller than a possible maximum value of the consumed power and larger than the possible minimum value of the consumed power in the power storage amount control, exclusively execute one of (i) charging of the battery with the supplied power and (ii) an operation of the temperature raising device with electric power in the battery without reception of the supplied power, to keep the power storage amount of the battery within the predetermined range.

The case where the supplied power is smaller than the possible maximum value of the consumed power and larger than the possible minimum value of the consumed power is rephrased as a case where the supplied power and the consumed power are approximately the same. For example, when the power storage amount of the battery is calculated by a current integration method, there is a possibility that an input/output current of the battery is mixed into a detection deviation of a sensor and the power storage amount cannot be calculated accurately. According to the configuration described above, the accuracy of the calculation of the power storage amount can be secured because one of the charging of the battery and the operation of the temperature raising device is executed exclusively.

(5) In the vehicle according to the aspect described above, an upper limit value of the predetermined range may be set, based on the supplied power and the consumed power, to a value that does not cause overcharging of the battery due to an increase in charging power of the battery in association with a stop of the temperature raising device during execution of the power storage amount control.

In the case where the temperature of the battery is raised during the external charging, the temperature raising device is stopped when the temperature of the battery reaches the reference temperature in the meantime. Then, the charging power increases by an amount of the consumed power of the temperature raising device. When the power storage amount of the battery is close to a full charge amount, there is a possibility that the battery is overcharged due to an increase in the charging power. According to the configuration described above, the upper limit value of the predetermined range is set to the value that does not cause the overcharging of the battery due to the increase in the charging power of the battery in association with the stop of the temperature raising device during the execution of the power storage amount control. By keeping the power storage amount of the battery within the predetermined range, the overcharging of the battery can be suppressed even if the charging power increases due to the stop of the temperature raising device.

A method for external charging according to a second aspect of the present disclosure is a method for external charging in which a battery in a vehicle is charged with supplied power that is supplied from a power supply outside the vehicle. A temperature of the battery is raisable by a temperature raising device. The method includes executing, in a period in which the temperature of the battery is lower than a reference temperature during execution of the external charging, power storage amount control for raising the temperature of the battery by driving the temperature raising device while keeping a power storage amount of the battery within a predetermined range, and keeping, when the supplied power is smaller than a possible minimum value of consumed power of the temperature raising device in the power storage amount control, the power storage amount of the battery within the predetermined range while intermittently operating the temperature raising device with the battery receiving supplied power continuously.

In the method according to the aspect described above, the external charging and the temperature raising device may be controlled by a control device provided at the vehicle.

According to the present disclosure, it is possible to suppress an increase in the period required for the external charging when the temperature of the battery is lower than the reference temperature during the external charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a vehicle according to an embodiment;

FIG. 2 is a diagram illustrating first constant SOC control;

FIG. 3 is a diagram illustrating second constant SOC control;

FIG. 4 is a diagram illustrating third constant SOC control; and

FIG. 5 is a flowchart showing a procedure of a process to be executed by an electronic control unit (ECU) during alternating current (AC) charging.

### DETAILED DESCRIPTION OF EMBODIMENTS

An embodiment of the present disclosure will be described in detail below with reference to the drawings. The same or corresponding parts are denoted by the same signs throughout the drawings, and description thereof will not be repeated.

### Overall Configuration Diagram

### Vehicle

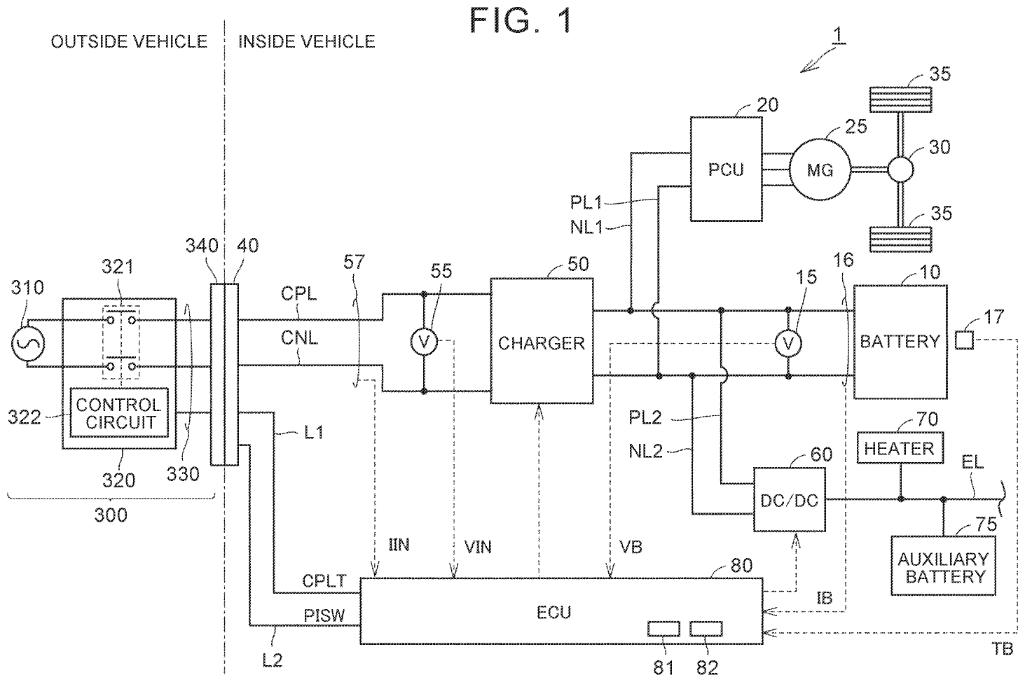

FIG. 1 is a diagram showing a configuration of a vehicle 1 according to the present embodiment. The vehicle 1 according to the present embodiment is a battery electric vehicle. The vehicle 1 is not limited to the battery electric vehicle as long as the vehicle 1 is capable of external charging in which an on-board battery (battery in the vehicle) is charged with electric power supplied from a power supply outside the vehicle 1. For example, the vehicle 1 may be a plug-in hybrid electric vehicle or a fuel cell electric vehicle.

Referring to FIG. 1, the vehicle 1 includes a battery 10, a voltage sensor 15, a current sensor 16, a temperature sensor 17, a power control unit (hereinafter referred to also as “PCU”) 20, a motor generator 25, a power transmission gear 30, drive wheels 35, an inlet 40, a charger 50, a voltage sensor 55, a current sensor 57, a direct current-to-direct current (DC/DC) converter 60, a heater 70, an auxiliary battery 75, and an electronic control unit (ECU) 80. The vehicle 1 according to the present embodiment is capable of AC charging in which the battery 10 is charged with AC power supplied from an AC charging facility 300 outside the vehicle. In the AC charging of the present embodiment, the AC power supplied from the AC charging facility 300 may be used not only for charging the battery 10 but also for driving on-board devices. That is, in the present embodiment, execution of the AC charging means reception of the AC power supplied from the AC charging facility 300.

The battery 10 is mounted on the vehicle 1 as a drive power supply (that is, a power source). The battery 10 includes a plurality of stacked cells. The cell is a secondary battery such as a nickel metal hydride battery or a lithium ion battery. The cell may be a battery having a liquid electrolyte between a positive electrode and a negative electrode, or may be a battery having a solid electrolyte between a positive electrode and a negative electrode (solid-state battery).

The voltage sensor 15, the current sensor 16, and the temperature sensor 17 function as a monitoring unit for the battery 10. The voltage sensor 15 detects a voltage VB of the battery 10, and outputs a signal indicating the detection result to the ECU 80. The current sensor 16 detects an input/output current (battery current) IB of the battery 10, and outputs a signal indicating the detection result to the ECU 80. The temperature sensor 17 detects a temperature (battery temperature) TB of the battery 10, and outputs a signal indicating the detection result to the ECU 80.

The PCU 20 is electrically connected to the battery 10 by power lines PL1 and NL1. The PCU 20 converts DC power stored in the battery 10 into AC power and supplies the AC power to the motor generator 25 in response to a control signal from the ECU 80. The PCU 20 also converts AC power generated by the motor generator 25 into DC power and supplies the DC power to the battery 10. The PCU 20 includes, for example, an inverter and a converter that steps up a DC voltage supplied to the inverter to an output voltage of the battery 10 or higher.

The motor generator 25 is an AC rotating electrical machine such as a permanent magnet kind synchronous motor including a rotor with embedded permanent magnets. The rotor of the motor generator 25 is mechanically connected to the drive wheels 35 via the power transmission gear 30. The motor generator 25 receives AC power from the PCU 20 to generate kinetic energy for causing the vehicle 1 to travel. The kinetic energy generated by the motor generator 25 is transmitted to the power transmission gear 30. When decelerating the vehicle 1 or stopping the vehicle 1, the motor generator 25 converts the kinetic energy of the vehicle 1 into electrical energy. The AC power generated by the motor generator 25 is converted into DC power and supplied to the battery 10 by the PCU 20. As a result, regenerative power can be stored in the battery 10. In this way, the motor generator 25 is configured to generate a driving force or a braking force of the vehicle 1 along with the transfer of electric power to and from the battery 10 (that is, charging/discharging of the battery 10).

A connector 340 of the AC charging facility 300 can be connected to the inlet 40. The inlet 40 is electrically connected to the charger 50 by power lines CPL and CNL. Signal lines L1 and L2 are provided between the inlet 40 and the ECU 80. The signal line L1 is a signal line for transmitting a pilot signal (CPLT signal) for exchanging predetermined information between the vehicle 1 and the AC charging facility 300. Details of the CPLT signal will be described later. The signal line L2 is a signal line for transmitting a connector connection signal PISW indicating a connection status between the inlet 40 and the connector 340. The signal level of the connector connection signal PISW changes depending on the connection status between the inlet 40 and the connector 340. That is, the connector connection signal PISW has different potentials between a case where the inlet 40 and the connector 340 are connected and a case where the inlet 40 and the connector 340 are not connected. The ECU 80 can detect the connection status between the inlet 40 and the connector 340 by detecting the potential of the connector connection signal PISW.

The charger 50 is electrically connected between the battery 10 and the inlet 40. The charger 50 includes, for example, an AC/DC converter, a DC/AC converter, an isolation transformer, and the like. The charger 50 converts electric power received from the AC charging facility 300 via the inlet 40 into electric power for charging the battery 10 based on a control signal from the ECU 80 and supplies the electric power to the battery 10. The charger 50 may be capable of bidirectional power conversion. In this case, the charger 50 converts electric power received from the battery 10 into AC power based on a control signal from the ECU 80 and supplies the electric power to the AC charging facility 300.

The voltage sensor 55 is provided between the power lines CPL and CNL electrically connecting the inlet 40 and the charger 50. The voltage sensor 55 detects a voltage VIN between the power lines CPL and CNL, and outputs a signal indicating the detection result to the ECU 80.

The current sensor 57 detects a current IIN flowing through the power lines CPL and CNL, and outputs a signal indicating the detection result to the ECU 80.

The DC/DC converter 60 is electrically connected between power lines PL2 and NL2 and a low voltage line EL. The DC/DC converter 60 steps down a voltage between the power lines PL2 and NL2, and supplies the voltage to the low voltage line EL. The DC/DC converter 60 operates in response to a control signal from the ECU 80.

Various auxiliary devices are electrically connected to the low voltage line EL. In FIG. 1, the heater 70 is exemplified as the auxiliary device. The auxiliary battery 75 is electrically connected to the low voltage line EL. The ECU 80 is also electrically connected to the low voltage line EL.

The heater 70 can raise the temperature of the battery 10. The heater 70 includes an electric resistor that heats the battery 10 by generating Joule heat with electric power supplied from the DC/DC converter 60. The heat generation amount (energization amount) of the heater 70 is controlled by the ECU 80. In the present embodiment, the heat generation amount of the heater 70 is controlled to be constant (for example, the maximum heat generation amount) by the ECU 80 during execution of the AC charging. The heater 70 corresponds to an example of a “temperature raising device” according to the present disclosure.

The ECU 80 includes a central processing unit (CPU) 81, a memory 82, and an input/output port (not shown). The memory 82 includes a read-only memory (ROM) and a random access memory (RAM), and stores, for example, program(s) to be executed by the CPU 81. The CPU 81 loads the program(s) stored in the ROM into the RAM and executes the program(s). The CPU 81 executes a predetermined arithmetic process(es) based on various signals input from the input/output port and information stored in the memory 82, and controls devices such as the PCU 20, the charger 50, and the DC/DC converter 60 and the AC charging facility 300 based on an arithmetic result(s). The control is not limited to software processing, but can also be constructed and processed by dedicated hardware (electronic circuits).

The memory 82 stores specification information of the heater 70. The specification information of the heater 70 includes, for example, a control variation value a of the heater 70 and power consumption information of the heater 70. The control variation value a is generated, for example, due to a design variation of the heater 70.

The memory 82 also stores a map for deriving an output power limit value Wout of the battery 10. The map defines a relationship among the SOC of the battery 10, the battery temperature TB, and the output power limit value Wout. The ECU 80 can calculate the output power limit value Wout by using the map with the SOC of the battery 10 and the battery temperature TB as arguments. The map can be derived from, for example, specification of the vehicle 1, simulation results, or experimental results.

The ECU 80 calculates the SOC of the battery 10. A known method such as a current integration method or an open circuit voltage (OCV) estimation method can be adopted as a method for calculating the SOC. In the present embodiment, the ECU 80 calculates the SOC by the current integration method.

The ECU 80 controls the AC charging. When the AC charging is started, the ECU 80 controls the charger 50 to charge the battery 10 so that the SOC of the battery 10 reaches a target SOC. The target SOC is, for example, a full charge level. The target SOC may be, for example, an SOC set by a user of the vehicle 1. The user of the vehicle 1 can set the target SOC by, for example, operating a navigation device (not shown) of the vehicle 1 or operating the AC charging facility 300. In the present embodiment, it is assumed that the target SOC is the full charge level. The full charge level is an SOC that is an upper limit for the control on the battery 10.

The ECU 80 executes a process of raising the temperature of the battery 10 when the battery temperature TB is lower than a reference temperature Tth during the AC charging. When the heater 70 is driven to raise the temperature of the battery 10 during the AC charging, the ECU 80 executes constant SOC control for keeping the SOC within a predetermined range without fully charging the battery 10 until the temperature raising of the battery 10 is completed. The constant SOC control is executed to suppress overcharging of the battery 10. When the temperature of the battery 10 is raised while the AC charging is executed, the electric power supplied from the AC charging facility 300 to the vehicle 1 (hereinafter referred to also as “supplied power Pc”) is divided into charging power PB for charging the battery 10 and driving power (consumed power) Ph for the heater 70. When the temperature raising of the battery 10 is completed and the heater 70 is stopped with the battery 10 charged to a level just before the full charge level, the consumed power Ph of the heater 70 is turned into the charging power PB, and the charging power PB increases by an amount of the consumed power Ph of the heater 70. Since the battery 10 has already been charged to the level just before the full charge level, there is a possibility of overcharging of the battery 10. Therefore, when the temperature of the battery 10 is raised while the AC charging is executed, the overcharging of the battery 10 can be suppressed by keeping the SOC within the predetermined range.

The predetermined range is defined by an upper limit value and a lower limit value. The upper limit value of the predetermined range can be defined, for example, based on the supplied power Pc, the consumed power Ph of the heater 70, and the specifications related to the overcharging of the battery 10. The specifications related to the overcharging of the battery 10 can be recognized in advance, for example, at a design stage of the vehicle 1. Therefore, the upper limit value of the predetermined range can be defined based on the supplied power Pc and the consumed power Ph of the heater 70 so as not to cause the overcharging of the battery 10 when the heater 70 is stopped. The lower limit value of the predetermined range is set, for example, to a value smaller than the upper limit value of the predetermined range by several percent of the SOC (for example, 1%) based on the specifications related to the power storage amount of the battery 10. Further details of the constant SOC control will be described later. The constant SOC control corresponds to an example of “power storage amount control” according to the present disclosure.

The ECU 80 can be divided into a plurality of ECUs for individual functions. For example, the ECU 80 may be divided into an ECU having a function of controlling the charging of the battery 10 and an ECU having a function of controlling the heater 70.

### AC Charging Facility

The AC charging facility 300 includes an AC power supply 310, electric vehicle supply equipment (EVSE) 320, and a charging cable 330. The connector 340 connectable to the inlet 40 of the vehicle 1 is provided at the distal end of the charging cable 330.

The AC power supply 310 is, for example, a commercial mains power supply, but is not limited to the commercial mains power supply and various power supplies can be applied.

The EVSE 320 controls supply and interruption of AC power from the AC power supply 310 to the vehicle 1 via the charging cable 330. The EVSE 320 includes a charging circuit interrupt device (CCID) 321 and a CPLT control circuit 322. The CCID 321 is a relay provided in a power supply path from the AC power supply 310 to the vehicle 1.

The CPLT control circuit 322 generates a CPLT signal (pilot signal) and transmits the generated CPLT signal to the ECU 80 of the vehicle 1 via a signal line included in the charging cable 330. The potential of the CPLT signal is manipulated by the ECU 80. The CPLT control circuit 322 controls the CCID 321 based on the potential of the CPLT signal. That is, the ECU 80 can remotely control the CCID 321 by manipulating the potential of the CPLT signal. Known methods can be used as methods for changing the potential of the CPLT signal. Although detailed description is not given herein, a circuit configuration disclosed in, for example, Japanese Unexamined Patent Application Publication No. 2016-82801 (JP 2016-82801 A) can be applied.

### Battery Temperature Raising During AC Charging

In the AC charging, when the temperature of the battery is lower than the reference temperature, it is desirable to operate the heater 70 to raise the temperature of the battery 10 to the reference temperature Tth or higher. The reference temperature Tth is defined based on electric power required to cause the vehicle 1 to travel after the AC charging. For example, a value obtained by adding a predetermined margin to the electric power required to cause the vehicle 1 to travel is set as the output power limit value Wout, and a temperature derived by checking the output power limit value Wout and the SOC at the completion of the AC charging against the map can be set as the reference temperature Tth. The SOC at the completion of the AC charging is, for example, the full charge level.

It is desirable to quickly complete the temperature raising of the battery 10 to shorten a period required for the AC charging. When the electric power supplied from the AC charging facility 300 to the vehicle 1 (supplied power Pc) is sufficiently large relative to the consumed power Ph of the heater 70, the charging of the battery 10 and the driving of the heater 70 can be executed simultaneously. On the other hand, the supplied power Pc may be small to the extent that the charging of the battery 10 and the driving of the heater 70 cannot be executed simultaneously. When the charging of the battery 10 and the driving of the heater 70 are executed simultaneously in a case where the supplied power Pc and the consumed power Ph of the heater 70 are approximately the same, the battery current IB (charging/discharging current) decreases and is mixed into a detection deviation of the current sensor 16. Therefore, the SOC cannot accurately be calculated by the current integration method. In the vehicle 1 according to the present embodiment, the ECU 80 selectively executes first constant SOC control to third constant SOC control depending on the relationship between the supplied power Pc and the consumed power Ph of the heater 70 instead of performing one kind of constant SOC control in every case.

Specifically, in consideration of the control variation value a of the heater 70, the ECU 80 compares the supplied power Pc with a possible maximum value Ph+α of the consumed power Ph of the heater 70 and with a possible minimum value Ph−α of the consumed power Ph of the heater 70. The ECU 80 executes the first constant SOC control when the supplied power Pc is larger than the maximum value Ph+α (Pc>Ph+α). The ECU 80 executes the second constant SOC control when the supplied power Pc is smaller than the minimum value Ph−α (Pc<Ph−α). The ECU 80 executes the third constant SOC control when the supplied power Pc is equal to or smaller than the maximum value Ph+α and equal to or larger than the minimum value Ph−α (Ph−α≤Pc≤Ph+α). In the present embodiment, as described above, the heater 70 is controlled by the ECU 80 so that the heat generation amount (power consumption) is constant (for example, the maximum heat generation amount). When the heat generation amount is changed every time, the consumed power Ph of the heater 70 may be calculated every time.

Pc>Ph+α (1) First Constant SOC Control:

In the first constant SOC control, the charging and the temperature raising of the battery 10 are executed simultaneously from the start of the AC charging. After the SOC of the battery 10 reaches the upper limit value of the predetermined range, the charging is intermittently executed while the temperature raising continues at all times until the battery temperature TB reaches the reference temperature Tth.

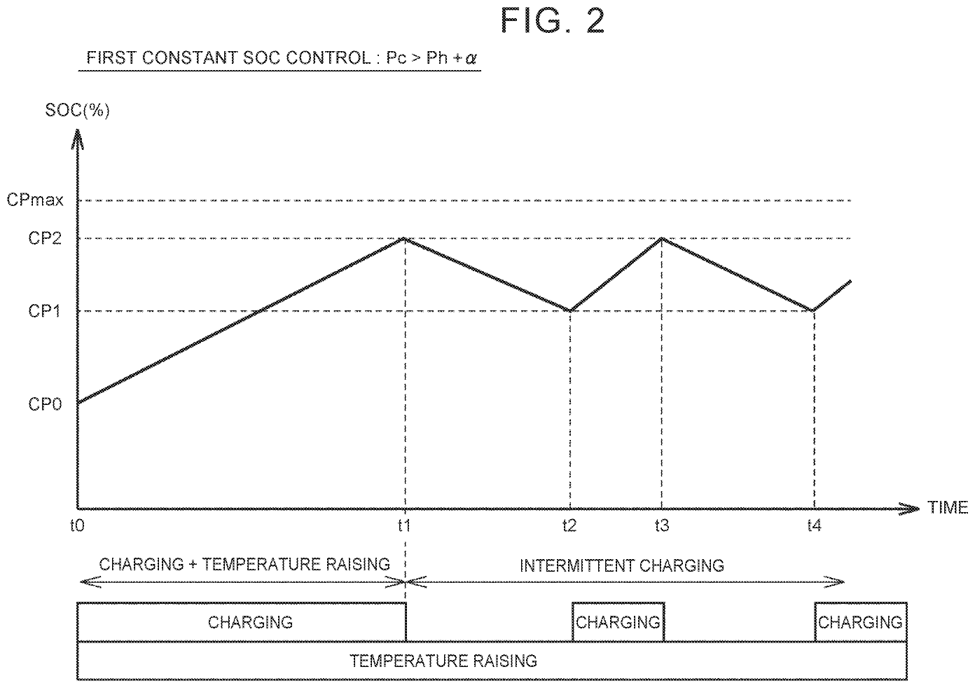

FIG. 2 is a diagram illustrating the first constant SOC control. In FIG. 2 and FIGS. 3 and 4 described later, the vertical axes represent the SOC of the battery 10, and the horizontal axes represent time. On the vertical axes, CPO indicates an SOC of the battery 10 at the start of the AC charging, CP1 indicates the lower limit value of the predetermined range, CP2 indicates the upper limit value of the predetermined range, and CPmax indicates an SOC of the fully charged battery 10.

At a time t0, the ECU 80 starts the AC charging to charge the battery 10 with a part of the supplied power Pc, and starts the temperature raising of the battery 10 by driving the heater 70 with a part of the supplied power Pc. As a result, the SOC of the battery 10 increases, and the battery temperature TB also increases. In FIG. 2 and FIGS. 3 and 4 described later, it is assumed that the battery temperature TB is lower than the reference temperature Tth.

When the SOC of the battery 10 reaches the upper limit value CP2 of the predetermined range at a time t1, the ECU 80 stops the supply of the supplied power Pc from the AC charging facility 300, and drives the heater 70 with the electric power in the battery 10. That is, the charging of the battery 10 is stopped, but the temperature of the battery 10 continues to rise. As a result, the SOC of the battery 10 decreases from the upper limit value CP2 during a period from the time t1 to a time t2. The stop of the supply of the supplied power Pc during the AC charging is realized by, for example, opening the CCID 321. The CCID 321 is remotely operated by, for example, the ECU 80 manipulating the potential of the CPLT signal.

When the SOC of the battery 10 decreases to the lower limit value CP1 of the predetermined range at the time t2, the ECU 80 restarts the supply of the supplied power Pc from the AC charging facility 300 to charge the battery 10 and raise the temperature of the battery 10 with the supplied power Pc. As a result, the SOC of the battery 10 increases during a period from the time t2 to a time t3.

When the SOC of the battery 10 reaches the upper limit value CP2 of the predetermined range at the time t3, the ECU 80 stops the supply of the supplied power Pc from the AC charging facility 300, and drives the heater 70 with the electric power in the battery 10. As a result, the SOC of the battery 10 decreases from the upper limit value CP2 during a period from the time t3 to a time t4.

When the SOC of the battery 10 decreases to the lower limit value CP1 of the predetermined range at the time t4, the ECU 80 restarts the supply of the supplied power Pc from the AC charging facility 300 to charge the battery 10 and raise the temperature of the battery 10 with the supplied power Pc.

In this manner, the ECU 80 raises the battery temperature TB to the reference temperature Tth or higher while keeping the SOC of the battery 10 within the predetermined range. When the battery temperature TB is equal to or higher than the reference temperature Tth, the ECU 80 terminates the first constant SOC control and charges the battery 10 to CPmax (full charge level). When the SOC of the battery 10 reaches CPmax, the ECU 80 terminates the AC charging.

Pc<Ph−α (2) Second Constant SOC Control:

In the second constant SOC control, the battery 10 is first charged to the upper limit value CP2 of the predetermined range without raising the temperature of the battery 10. After the SOC of the battery 10 reaches the upper limit value of the predetermined range, the temperature is intermittently raised while the supply of the supplied power Pc from the AC charging facility 300 is allowed to continue until the battery temperature TB reaches the reference temperature Tth. That is, the supply of the supplied power Pc from the AC charging facility 300 is continued throughout the second constant SOC control.

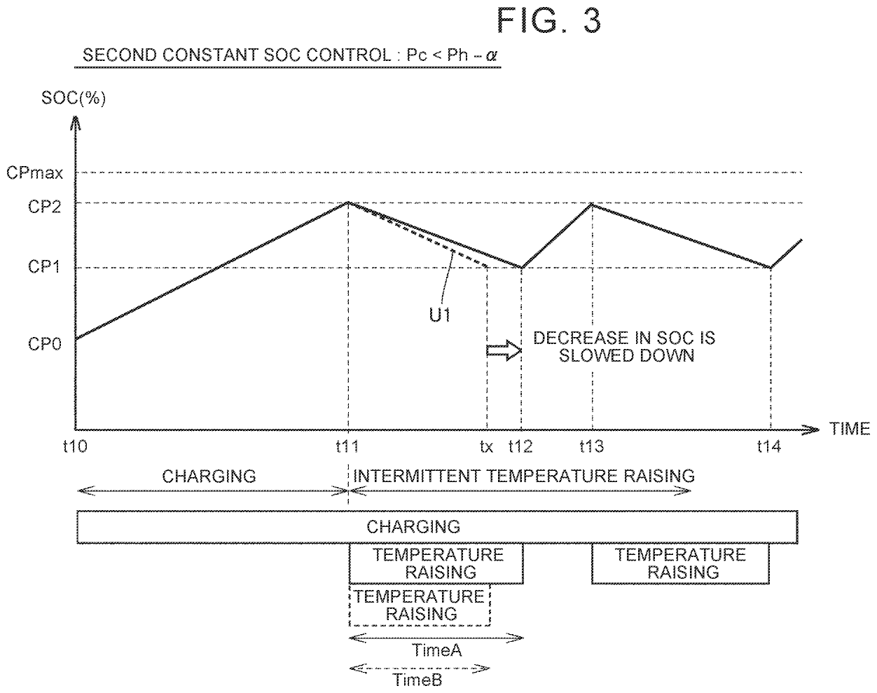

FIG. 3 is a diagram illustrating the second constant SOC control. At a time t10, the ECU 80 starts the AC charging to start charging the battery 10 with the supplied power Pc. As a result, the SOC of the battery 10 increases during a period from the time t10 to a time t11.

When the SOC of the battery 10 reaches the upper limit value CP2 of the predetermined range at the time t11, the ECU 80 stops charging the battery 10 (PB=0), and uses the supplied power Pc to drive the heater 70. A shortage of the electric power for driving the heater 70 is compensated with the electric power taken out from the battery 10. As a result, the SOC of the battery 10 decreases from the upper limit value CP2 during a period from the time t11 to a time t12.

When the SOC of the battery 10 decreases to the lower limit value CP1 of the predetermined range at the time t12, the ECU 80 stops the heater 70 to stop raising the temperature of the battery 10. Then, the ECU 80 charges the battery 10 by using the supplied power Pc for charging the battery 10 (PB=Pc). As a result, the SOC of the battery 10 increases during a period from the time t12 to a time t13. Focusing on the temperature raising of the battery 10, the temperature of the battery 10 is raised only during the period from the time t11 to the time t12 (temperature raising period TimeA).

In FIG. 3, a dashed line U1 indicates a relationship between the SOC and the time in a case where the supply of the supplied power Pc from the AC charging facility 300 is stopped when the SOC of the battery 10 reaches the upper limit value CP2 of the predetermined range. When the supply of the supplied power Pc from the AC charging facility 300 is stopped, the electric power for driving the heater 70 is taken out from the battery 10. Therefore, the SOC of the battery 10 decreases to the lower limit value CP1 more quickly than in a case where the supply of the supplied power Pc from the AC charging facility 300 is continued. The heater 70 is stopped at this time point. That is, a temperature raising period TimeB of the battery 10 in this case is a period from the time t11 to a time tx (t11<tx<t12). The temperature raising period TimeB is shorter than the temperature raising period TimeA. By continuing the supply of the supplied power Pc from the AC charging facility 300, the decrease in the SOC of the battery 10 can be slowed down. As a result, the temperature raising period of the battery 10 can be lengthened. Thus, the temperature raising of the battery 10 can be completed quickly (the battery temperature TB can quickly be raised to the reference temperature Tth or higher).

When the SOC of the battery 10 reaches the upper limit value CP2 of the predetermined range at the time t13, the ECU 80 stops charging the battery 10 (PB=0), and uses the supplied power Pc to drive the heater 70. A shortage of the electric power for driving the heater 70 is compensated with the electric power taken out from the battery 10. As a result, the SOC of the battery 10 decreases from the upper limit value CP2 during a period from the time t13 to a time t14.

When the SOC of the battery 10 decreases to the lower limit value CP1 of the predetermined range at the time t14, the ECU 80 stops the heater 70 and charges the battery 10 with the supplied power Pc.

In this manner, the ECU 80 raises the battery temperature TB to the reference temperature Tth or higher while keeping the SOC of the battery 10 within the predetermined range. By continuing the supply of the supplied power Pc from the AC charging facility 300 during the execution of the second constant SOC control, the decrease in the SOC during the heater driving can be slowed down and the temperature raising period can be lengthened. When the battery temperature TB is equal to or higher than the reference temperature Tth, the ECU 80 terminates the second constant SOC control and charges the battery 10 to CPmax (full charge level). When the SOC of the battery 10 reaches CPmax, the ECU 80 terminates the AC charging.

The above description is directed to the example in which, when the SOC of the battery 10 reaches the upper limit value CP2 of the predetermined range, the charging of the battery 10 is stopped (PB=0) and the supplied power Pc is used to drive the heater 70. The driving power of the heater 70 may be taken out from the battery 10 while charging the battery 10 with the supplied power Pc (PB=Pc).

Ph−α≤Pc≤Ph+α (3) Third Constant SOC Control:

In the third constant SOC control, the battery 10 is first charged to the upper limit value CP2 of the predetermined range without raising the temperature of the battery 10. After the SOC of the battery 10 reaches the upper limit value of the predetermined range, one of the charging and the temperature raising of the battery 10 is executed exclusively until the battery temperature TB reaches the reference temperature Tth. That is, in the third constant SOC control, the charging and the temperature raising of the battery 10 are alternately executed. More specifically, in the third constant SOC control, the charging of the battery 10 with the supplied power Pc received from the AC charging facility 300 and the temperature raising of the battery 10 by the driving of the heater 70 with the electric power in the battery 10 in a state in which the supply of the supplied power Pc from the AC charging facility 300 is stopped are alternately executed.

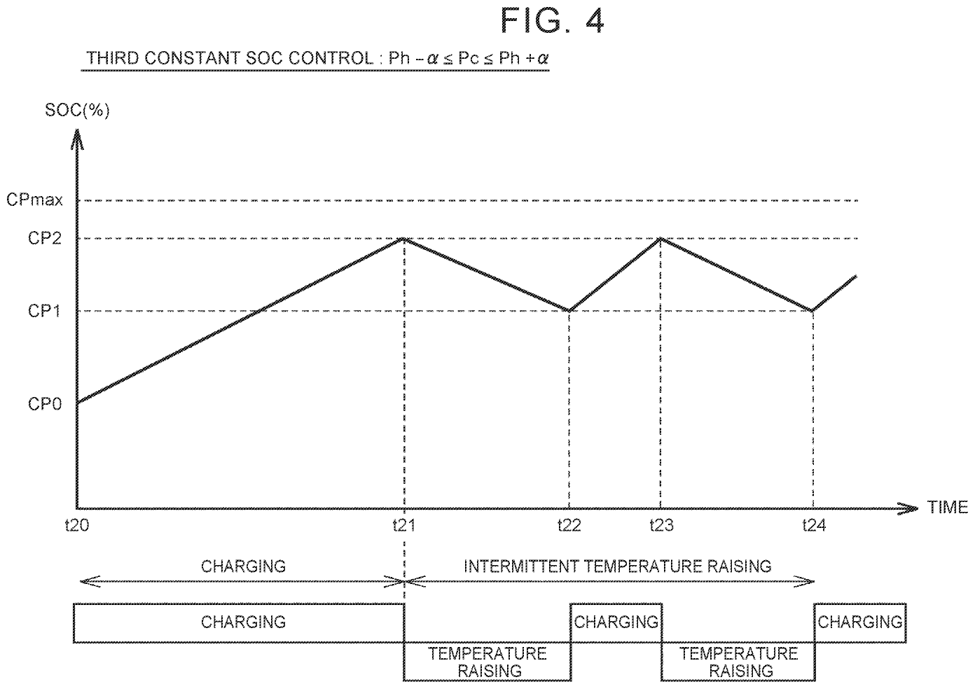

FIG. 4 is a diagram illustrating the third constant SOC control. At a time t20, the ECU 80 starts the AC charging to start charging the battery 10 with the supplied power Pc. As a result, the SOC of the battery 10 increases during a period from the time t20 to a time t21.

When the SOC of the battery 10 reaches the upper limit value CP2 of the predetermined range at the time t21, the ECU 80 stops the supply of the supplied power Pc from the AC charging facility 300 to stop charging the battery 10. Then, the ECU 80 drives the heater 70 with the electric power in the battery 10 to raise the temperature of the battery. As a result, the SOC of the battery 10 decreases from the upper limit value CP2 during a period from the time t21 to a time t22.

When the SOC of the battery 10 decreases to the lower limit value CP1 of the predetermined range at the time t22, the ECU 80 stops the heater 70 to stop raising the temperature of the battery 10. Then, the ECU 80 restarts the supply of the supplied power Pc from the AC charging facility 300 to charge the battery 10. As a result, the SOC of the battery 10 increases during a period from the time t22 to a time t23.

When the SOC of the battery 10 reaches the upper limit value CP2 of the predetermined range at the time t23, the ECU 80 stops the supply of the supplied power Pc from the AC charging facility 300 to stop charging the battery 10. Then, the ECU 80 drives the heater 70 with the electric power in the battery 10 to raise the temperature of the battery. As a result, the SOC of the battery 10 decreases from the upper limit value CP2 during a period from the time t23 to a time t24.

When the SOC of the battery 10 decreases to the lower limit value CP1 of the predetermined range at the time t24, the ECU 80 stops the heater 70 and restarts the supply of the supplied power Pc from the AC charging facility 300 to charge the battery 10 with the supplied power Pc.

In this manner, the ECU 80 raises the battery temperature TB to the reference temperature Tth or higher while keeping the SOC of the battery 10 within the predetermined range. When the charging of the battery 10 and the driving of the heater 70 are executed simultaneously in the case where the supplied power Pc and the consumed power Ph of the heater 70 are approximately the same (Ph−α≤P≤c Ph+α), the battery current IB (charging/discharging current) decreases and is mixed into the detection deviation of the current sensor 16. Therefore, the SOC cannot accurately be calculated by the current integration method. In this case, the SOC calculation accuracy can be secured by exclusively executing one of the charging and the temperature raising of the battery 10. When the battery temperature TB is equal to or higher than the reference temperature Tth, the ECU 80 terminates the third constant SOC control and charges the battery 10 to CPmax (full charge level). When the SOC of the battery 10 reaches CPmax, the ECU 80 terminates the AC charging.

### Process to Be Executed by ECU

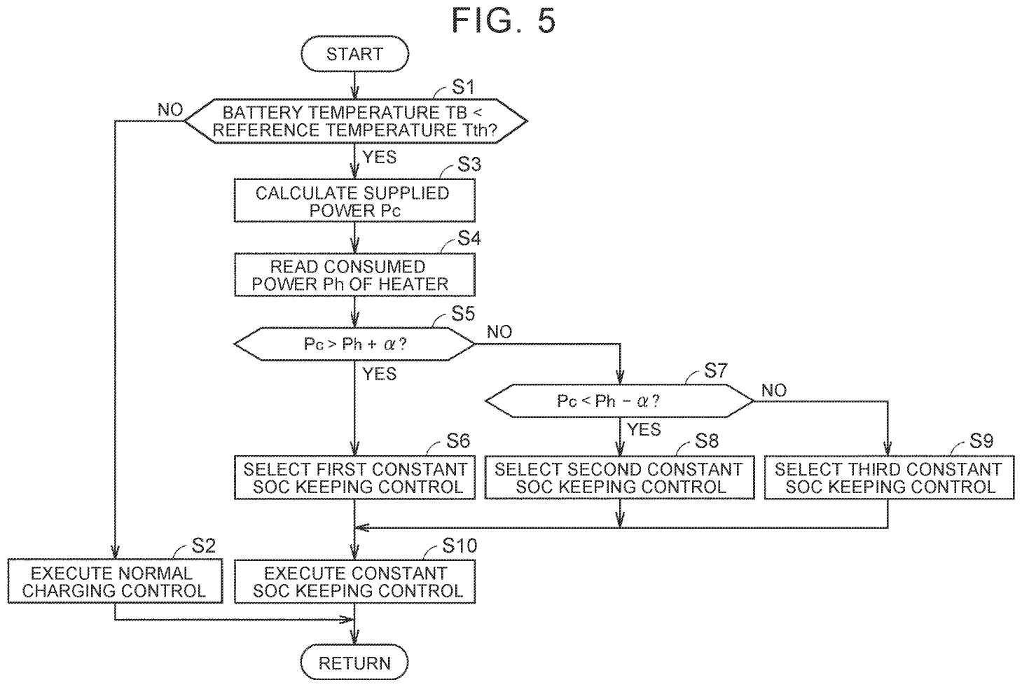

FIG. 5 is a flowchart showing a procedure of a process to be executed by the ECU during the AC charging. The process shown in the flowchart of FIG. 5 is started by the ECU 80 when an operation for starting the AC charging is performed. Examples of the operation for starting the AC charging include an operation on a charging start button (not shown) of the AC charging facility 300, an operation on a charging start icon displayed on a display screen of the navigation device (not shown) of the vehicle 1, and an operation of connecting the connector 340 to the inlet 40. Although description will be given to a case where each step (hereinafter abbreviated as “S”) in the flowchart of FIG. 5 is implemented by software processing by the ECU 80, a part or all of the steps may be implemented by hardware (electronic circuits) provided in the ECU 80.

In S1, the ECU 80 acquires the battery temperature TB from the temperature sensor 17 and determines whether the battery temperature TB is lower than the reference temperature Tth. When the ECU 80 determines that the battery temperature TB is equal to or higher than the reference temperature Tth (NO in S1), the ECU 80 advances the process to S2. When the ECU 80 determines that the battery temperature TB is lower than the reference temperature Tth (YES in S1), the ECU 80 advances the process to S3.

In S2, the ECU 80 executes normal charging control. In the normal charge control, the battery 10 is charged to the full charge level (CPmax) with the supplied power Pc supplied from the AC charging facility 300 by the AC charging. When the battery temperature TB is equal to or higher than the reference temperature Tth, it is not necessary to raise the temperature of the battery 10. Therefore, the constant SOC control is not executed and the battery 10 is charged to the full charge level.

In S3, the ECU 80 calculates the supplied power Pc supplied from the AC charging facility 300. Specifically, the ECU 80 calculates the supplied power Pc based on a rated current of the charging cable 330 and a voltage applied from the AC charging facility 300 to the inlet 40. The rated current of the charging cable 330 can be recognized, for example, based on a duty cycle of the CPLT signal. When the ECU 80 sets a current for the AC charging, the set current may be the rated current. The ECU 80 manipulates the potential of the CPLT signal to close the CCID 321 of the AC charging facility 300, and applies the voltage from the AC charging facility 300 to the inlet 40.

In S4, the ECU 80 reads the specification information of the heater 70 from the memory 82. The specification information of the heater 70 includes information on the consumed power Ph of the heater 70.

In S5, the ECU 80 compares the supplied power Pc with the consumed power Ph of the heater 70, and determines whether the supplied power Pc is larger than the possible maximum value Ph+α of the consumed power Ph. When the ECU 80 determines that the supplied power Pc is larger than the maximum value Ph+α (YES in S5), the ECU 80 advances the process to S6. When the ECU 80 determines that the supplied power Pc is equal to or smaller than the maximum value Ph+α (NO in S5), the ECU 80 advances the process to S7.

In S6, the ECU 80 selects execution of the first constant SOC control from among the three kinds of constant SOC control, and advances the process to S10.

In S7, the ECU 80 determines whether the supplied power Pc is smaller than the possible minimum value Ph−α of the consumed power Ph. When the ECU 80 determines that the supplied power Pc is smaller than the minimum value Ph−α (YES in S7), the ECU 80 advances the process to S8. When the ECU 80 determines that the supplied power Pc is equal to or larger than the minimum value Ph−α (NO in S7), the ECU 80 advances the process to S9.

In S8, the ECU 80 selects execution of the second constant SOC control from among the three kinds of constant SOC control, and advances the process to S10.

In S9, the ECU 80 selects execution of the third constant SOC control from among the three kinds of constant SOC control, and advances the process to S10.

In S10, the ECU 80 executes the constant SOC control selected in S6, S8, or S9.

As described above, the vehicle 1 according to the present embodiment includes the three kinds of constant SOC control, that is, the first constant SOC control to the third constant SOC control as the constant SOC control to be executed when raising the temperature of the battery 10 during the AC charging. The ECU 80 selectively executes the first constant SOC control to the third constant SOC control depending on the relationship between the supplied power Pc and the consumed power Ph of the heater 70.

The ECU 80 executes the first constant SOC control when the supplied power Pc is larger than the possible maximum value Ph+α of the consumed power Ph (Pc>Ph+α). As a result, the ECU 80 can quickly raise the temperature of the battery 10 while suppressing the overcharging of the battery 10 due to an increase in the charging power PB of the battery 10 in association with the stop of the heater 70.

The ECU 80 executes the second constant SOC control when the supplied power Pc is smaller than the possible minimum value Ph−α of the consumed power Ph (Pc<Ph−α). By the second constant SOC control continuing the supply of the supplied power Pc from the AC charging facility 300 at all times, the decrease in the SOC during the driving of the heater 70 (during the temperature raising) can be slowed down. Therefore, the temperature raising period can be lengthened as compared with the case where the supply of the supplied power Pc from the AC charging facility 300 is stopped during the driving of the heater 70. Thus, the battery temperature can quickly be raised to the reference temperature Tth or higher. Accordingly, the AC charging can be completed quickly. As a result, the execution of the second constant SOC control can suppress an increase in the AC charging period.

The ECU 80 executes the third constant SOC control when the supplied power Pc is equal to or smaller than the maximum value Ph+α and equal to or larger than the minimum value Ph−α (Ph−α≤Pc≤Ph+α). When the charging of the battery 10 and the driving of the heater 70 are executed simultaneously in the case where the supplied power Pc and the consumed power Ph of the heater 70 are approximately the same, the battery current IB (charging/discharging current) decreases and is mixed into the detection deviation of the current sensor 16. Therefore, the SOC cannot accurately be calculated by the current integration method. In this case, the SOC calculation accuracy can be secured by exclusively executing one of the charging and the temperature raising of the battery 10 by the third constant SOC control.

The embodiment disclosed herein shall be construed as illustrative and not restrictive in all respects. The scope of the present disclosure is shown by the claims rather than by the above description of the embodiment, and is intended to include all modifications within the meaning and scope equivalent to those of the claims.

What is claimed is:

1. A vehicle configured to perform external charging in which a battery in the vehicle is charged with supplied power that is supplied from a power supply outside the vehicle, the vehicle comprising:
the battery;
a temperature sensor configured to detect a temperature of the battery;
a temperature raising device configured to raise the temperature of the battery; and
a control device configured to control the external charging and the temperature raising device, wherein:
the control device is configured to, in a period in which the temperature of the battery is lower than a reference temperature during execution of the external charging, execute power storage amount control for raising the temperature of the battery by driving the temperature raising device while keeping a power storage amount of the battery within a predetermined range; and
the control device is configured to, when the supplied power is smaller than a possible minimum value of consumed power of the temperature raising device in the power storage amount control, keep the power storage amount of the battery within the predetermined range while intermittently operating the temperature raising device with the battery receiving the supplied power continuously.

2. The vehicle according to claim 1, wherein the control device is configured to, when the power storage amount of the battery decreases to a lower limit value of the predetermined range in the power storage amount control, stop the temperature raising device and charge the battery with the supplied power.

3. The vehicle according to claim 1, wherein the control device is configured to, when the supplied power is larger than a possible maximum value of the consumed power in the power storage amount control, intermittently charge the battery to keep the power storage amount of the battery within the predetermined range while operating the temperature raising device at all times.

4. The vehicle according to claim 1, wherein the control device is configured to, when the supplied power is smaller than a possible maximum value of the consumed power and larger than the possible minimum value of the consumed power in the power storage amount control, exclusively execute one of (i) charging of the battery with the supplied power and (ii) an operation of the temperature raising device with electric power in the battery without reception of the supplied power, to keep the power storage amount of the battery within the predetermined range.

5. The vehicle according to claim 1, wherein an upper limit value of the predetermined range is set, based on the supplied power and the consumed power, to a value that does not cause overcharging of the battery due to an increase in charging power of the battery in association with a stop of the temperature raising device during execution of the power storage amount control.

6. A method for external charging in which a battery in a vehicle is charged with supplied power that is supplied from a power supply outside the vehicle, a temperature of the battery being raisable by a temperature raising device, the method comprising:
executing, in a period in which the temperature of the battery is lower than a reference temperature during execution of the external charging, power storage amount control for raising the temperature of the battery by driving the temperature raising device while keeping a power storage amount of the battery within a predetermined range; and
keeping, when the supplied power is smaller than a possible minimum value of consumed power of the temperature raising device in the power storage amount control, the power storage amount of the battery within the predetermined range while intermittently operating the temperature raising device with the battery receiving the supplied power continuously.

7. The method according to claim 6, wherein the external charging and the temperature raising device are controlled by a control device provided in the vehicle.
